(19) United States
(12) Patent Application Publication
(10) Pub. No.: US 2010/0106527 A1
(43) Pub. Date: Apr. 29, 2010

(54) System and Method For Referral Management

(76) Inventor: Ernest B. Fisher, Altamonte Springs, FL (US)

Correspondence Address: McKinney Law, LLC, 121 S. Orange Ave, Suite 1500, Orlando, FL, 32801, US

(21) Appl. No.: 12/605,257

(22) Filed: Oct. 23, 2009

Related U.S. Application Data
(60) Provisional application No. 61/107,778, filed on Oct. 23, 2008.

(51) Int. Cl. G06Q 50/00; G06F 17/30; G06F 15/16

(52) U.S. Cl. 705/3; 707/769; 707/609; 709/219; 707/E17.108; 707/E17.005

(57) ABSTRACT

A system and method for referral management is disclosed. In a particular embodiment, the method includes receiving a referral request for a client submitted by a probation officer, storing the referral to a database on a remote server, and transferring the referral to a probation officer supervisor. The method further includes forwarding the referral to a contract supervisor when the referral is approved by the probation officer supervisor, forwarding the referral to a vendor when the referral is approved by the contract supervisor. In addition, the method includes receiving an acknowledgment that the referral was received by the vendor, receiving an evaluation from the vendor of the client, monitoring a progress of the client in a treatment program, completion of the treatment program by the client, notifying the contract supervisor of the completion of the treatment program by the client, and closing the referral.

### CROSS REFERENCE TO RELATED APPLICATIONS

This application claims the benefit of U.S. Provisional Application No. 61/107,778 filed Oct. 23, 2008. The disclosure of the provisional application is incorporated herein by reference.

### FIELD OF DISCLOSURE

The present invention relates in general to a system and method for referral management.

### BACKGROUND

Often times an offender in the criminal justice system is eligible to seek treatment for substance abuse as part of a process. In order for the offender (i.e., client) to seek treatment, the client must obtain a referral from his or her probation officer from the Department of Corrections (“DOC”). Communications and administration between the DOC and the contract providers of the substance abuse programs (i.e. vendors) has increasingly become very costly and labor intensive. For example, a DOC referral form is currently used for tracking and monitoring a client through the process. The referral form for each client is emailed and/or faxed back and forth between the probation officers, supervisors and vendors making it difficult to track and monitor the progress of the client in real time through the process. Both the vendors and the DOC need ways to operate more efficiently and reduce the amount of labor and material costs.

It is, therefore, to the effective resolution of the aforementioned problems and shortcomings of the prior art that the present method and system for referral management is directed.

### SUMMARY

In a particular embodiment, a method for referral management is disclosed. The method includes receiving a referral request for a client submitted by a probation officer, storing the referral to a database on a remote server, and transferring the referral to a probation officer supervisor. The method further includes forwarding the referral to a contract supervisor when the referral is approved by the probation officer supervisor, forwarding the referral to a vendor when the referral is approved by the contract supervisor. In addition, the method includes receiving an acknowledgment that the referral was received by the vendor, receiving an evaluation from the vendor of the client, monitoring a progress of the client in a treatment program, completion of the treatment program by the client, notifying the contract supervisor of the completion of the treatment program by the client, and closing the referral.

In another particular embodiment, a system for referral management is disclosed. The system includes a processor readable medium having processor instructions that are executable to cause a processor to receive at least one referral request for a client submitted by a probation officer, store the referral to a database on a remote server, and transfer the referral to a probation officer supervisor. The system forwards the referral to a contract supervisor when the referral is approved by the probation officer supervisor, forward the referral to a vendor when the referral is approved by the contract supervisor. In addition, the system receives an acknowledgment that the at least one referral request was received by the vendor, receive an evaluation from the vendor of the client, monitor a progress of the client in a treatment program, notify the contract supervisor of the completion of the treatment program by the client, and close the at least one referral request.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a flow chart of a particular illustrative embodiment of a method for referral management;

FIG. 2A is a representation of a Probation Officer (“PO”) Home page from a graphical user interface (“GUI”) for a particular embodiment of a system and method for referral management;

FIG. 2B is a representation of the PO Search page from the GUI for a particular embodiment of a system and method for referral management;

FIG. 2C is a representation of the PO Statistics page from the GUI for a particular embodiment of a system and method for referral management;

FIG. 2D is a representation of a Transfer page from the GUI for a particular embodiment of a system and method for referral management;

FIG. 3A is a representation of a PO Supervisor Home page from the GUI for a particular embodiment of a system and method for referral management;

FIG. 3B is a representation of a PO Supervisor Home page from the GUI for a particular embodiment of a system and method for referral management;

FIG. 4A is a representation of a Contract Supervisor Home page from the GUI for a particular embodiment of a system and method for referral management;

FIG. 4B is a representation of a Contract Supervisor Statistics page from the GUI for a particular embodiment of a system and method for referral management;

FIG. 5A is a representation of a Vendor Profile page from the GUI for a particular embodiment of a system and method for referral management;

FIG. 5B is a representation of a Vendor Security Center page from the GUI for a particular embodiment of a system and method for referral management;

FIG. 6 is a representation of an Offender Data Home page from the GUI for a particular embodiment of a system and method for referral management;

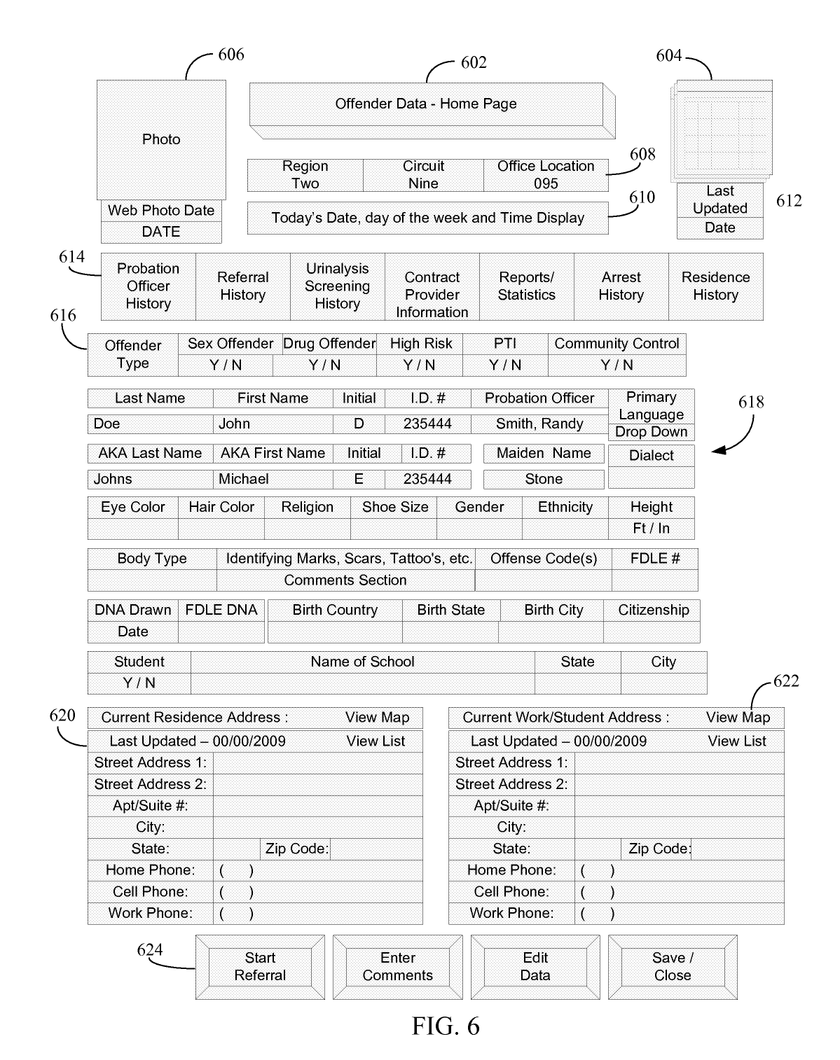

FIG. 7 is a representation of a DOC Security Center page from the GUI for a particular embodiment of a system and method for referral management;

FIG. 8 is a representation of an Offender Notes History page from the GUI for a particular embodiment of a system and method for referral management;

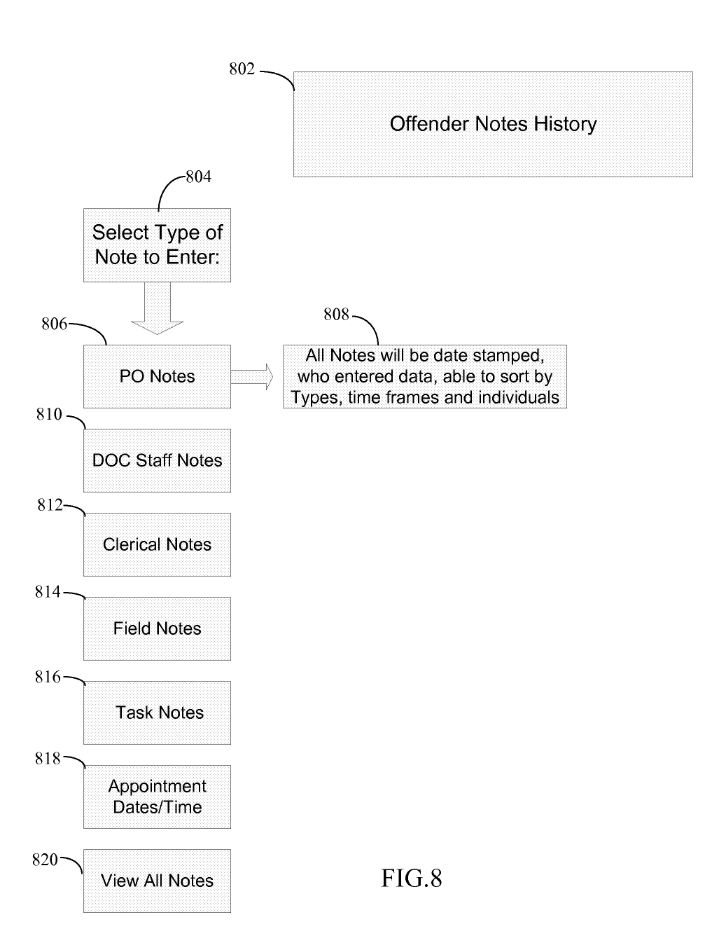

FIG. 9 is a block diagram of an illustrative embodiment of a general computer system; and

FIG. 10 is a block diagram of a particular illustrative embodiment of a system for referral management.

### DETAILED DESCRIPTION

The system for referral management includes an Internet based interactive customizable software program that connects the Department of Corrections (“DOC”) with vendors via a paperless (real time) process that includes a management tool that greatly reduces manpower hours, enhances productivity, provides several levels of security, management of budgeted funds, chain of custody tracking, provides uniformity across the state and provides statistics and reports as needed. The system and method provides secure access to multiple users in real time and allows the DOC and vendors to interact in real time. In addition, the system and method removes costly hardware maintenance and upgrades from the state responsibility because the system and method may be implemented on a database hosted on a remote server, which can be accessed using the Internet. Any upgrades to the system may be installed on the remote server so that the improvements become simultaneously and instantly available to all. An advantage of the system and method for referral management is the flexibility to be customized throughout the initial process and into the future.

With shrinking budgets and the cost of doing business climbing every day, a paperless process feature of the system not only eliminates the need of paper but reduces the use of copy machines, toner and fax machines for both the DOC and the vendors. The system and method of referral management provides the DOC the ability to manage a complex system of over 2,500 probation officers and staff and communicate with hundreds of vendors and interact with tens of thousands of offenders across the state in real time. Accordingly, the manpower needs are drastically reduced.

The real time paperless process of the method and system increases the productivity of all DOC staff members and vendors by, among other things, (1) eliminating the time for information movement in the current system, (2) the tracking of the information, (3) providing access from just about anywhere, (4) eliminating inconsistencies inherent in handwritten documents, and (5) saving tens of thousands of minutes on phone calls attempting to get information on offenders from vendors and within the DOC. Because the system and method for referral management is Internet based, the probation officers and staff can have access to their case loads anywhere they have connectivity, thereby providing immediate access to the information and simultaneously eliminating the travel time and expense.

In operation, once a referral request is approved by a Contract Supervisor and sent to a Vendor, the referral is locked and can only be edited by the Contract Supervisor. Currently the referral requests are e-mailed as an attachment (Word document) or part of the e-mail. This process has many opportunities to be sent to the wrong e-mail address, misplaced, or otherwise mishandled. In addition, currently a referral can be altered by anyone in the system without automatically tracking who made the change and when the change was made. The method and system for referral management provides a secure process in which the referral is accounted for with a history of the progression and who has accessed the referral, with automatic date/time and identification stamps. The method and system for referral management provides multi user and multi level access that is customizable to the DOC needs that ensures only authorized access to confidential data. Thus, internal document security is provided yet management is provided with the flexibility needed to provide constant access and real time monitoring. Security of the method and system meets or exceeds HIPPA requirements.

Another advantage of the method and system for referral management is a tracking feature and an ability to change a pay status and/or enter the pay status by the DOC or the vendors, which reduces funding issues and discrepancies on the billing. Another feature of the method and system for referral management provides the Contract Supervisor with the ability to monitor the amount of funds to each vendor by multiplying a number of referrals a vendor received by the level of treatment to calculate a dollar amount. Accordingly, the Contract Supervisor has the ability to make decisions based on projected information at any time and give the DOC the ability to manage the same projections for each circuit, region and/or the state. The method and system of referral management is automated and reduces the required manual steps by DOC to track and monitor an offender's progress. The system and method records by name and date each step in the process and may include visual aids to help in the managing of each offender's referral in real time.

The prior art referral systems do not provide a sense of consistency and tends to be frustrating to many users. By having a uniform program that the staff and vendors can rely on, increases the ease of use and the system becomes a partner in the pursuit to accomplish the goals of the DOC. Uniformity increases productivity and reduces the amount of frustrations caused by the current system. Uniformity provides the DOC with the ability to use consistent data for reports and statistics. The DOC benefits from reports and statistics generated by the method and system for referral management. Some examples include:
Treatment Levels;
Pay Status;
Circuit by Circuit or Region by Region;
Success rates of offenders and vendors;
No-Show Evaluation Reports;
Time between Date of Receipt of Referral by the Vendor and evaluation date;
Funding reports by Circuit and or Region;
Time between approvals by PO Supervisors and Contract Supervisors;
Vendors contract requirements;
Number of Clients/Offenders by Office, Circuit and Region;
Number of Probation Officers by Office, Circuit, Region;
Number of Clients/Offenders per Probation Officer, Office, Circuit, Region; and
Auditing tool for oversight of Vendors.

Advantages to using the method and system for referral management include no major hardware equipment or upgrades are required. Instead, the DOC current Internet access system is sufficient, only currently requiring Internet Explorer (6.0 or higher) to have access. There is a substantial reduction of expenses due to savings related to faxing, faxing machines, toner, paper and related energy expenditures. Further, a substantial labor reduction on handling referrals by Probation Officers, PO Supervisors, Vendors and the DOC. An ability to manage internally the progression of the referral approval process in a real time environment is also another advantage. The system and method have the ability to access and manage referrals from anywhere Internet access is available. Data can be received from the Vendors in a real time environment. There is also standardization statewide of the referral and an ability to create reports that are made possible due to standardization of the reporting of data. In addition, the system and method provides from the state level to the probation officer level real time statistics such as how many referrals are “Pending” (awaiting Contract Supervisor approval), “Active” (in treatment by a Vendor), or “Closed” (referral is closed by DOC or the Vendor).

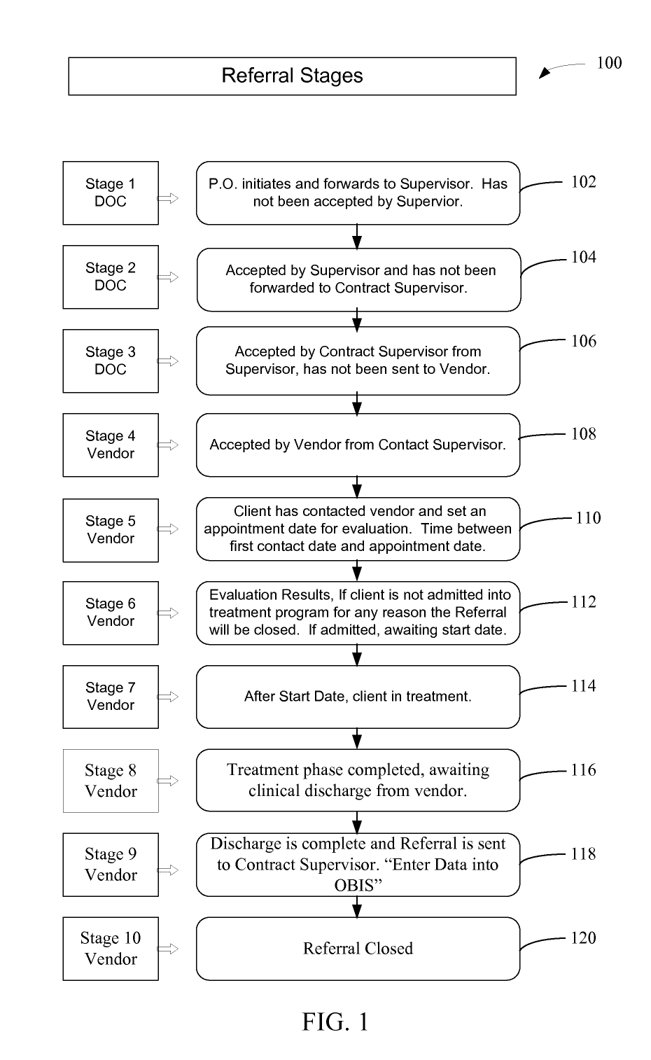

Referring now to FIG. 1, the Probation Officer (“PO”) initiates the referral request for a client, at 102, and automatically forwards the referral to a PO Supervisor for approval. The referral is assigned a “Pending” status. At 104, the PO Supervisor denies or approves the referral. If the referral is approved, the referral is forwarded to a Contract Supervisor for approval, at 106. The Contract Supervisor, at 108, denies or approves the referral. If approved, the referral is forwarded to a Vendor, at 108. The Contract Provider receives and acknowledges the referral by the act of receiving (date stamp) of the referral. Moving to 110, the client contacts the Vendor and sets an appointment date for evaluation. The time between the first contact date and the appointment date is recorded to encourage timely processing of the referral due to the built in accountability of the system. The Vendor uses a graphical user interface to enter information, which is available as each item is completed in real time to the DOC. Continuing to 112, if a client (i.e., “offender”) is admitted into treatment, then the referral continues in the “Active” status, at 114. If the client does not enter treatment the referral is closed. If the offender No-Shows, then the evaluation may be closed out and a new referral needed before the offender can reschedule. This places the referral in the PO “Attention” task list. The addition of these features provides insight to new management enhancements and productivity in areas not yet realized in the field. Moving to 116, the treatment phase is completed and the client awaits discharge from the Vendor. The discharge is completed and the referral is sent back to the Contract Supervisor, at 118, and the pertinent data may be transferred to the DOC OBIS system. At 120, the referral is closed.

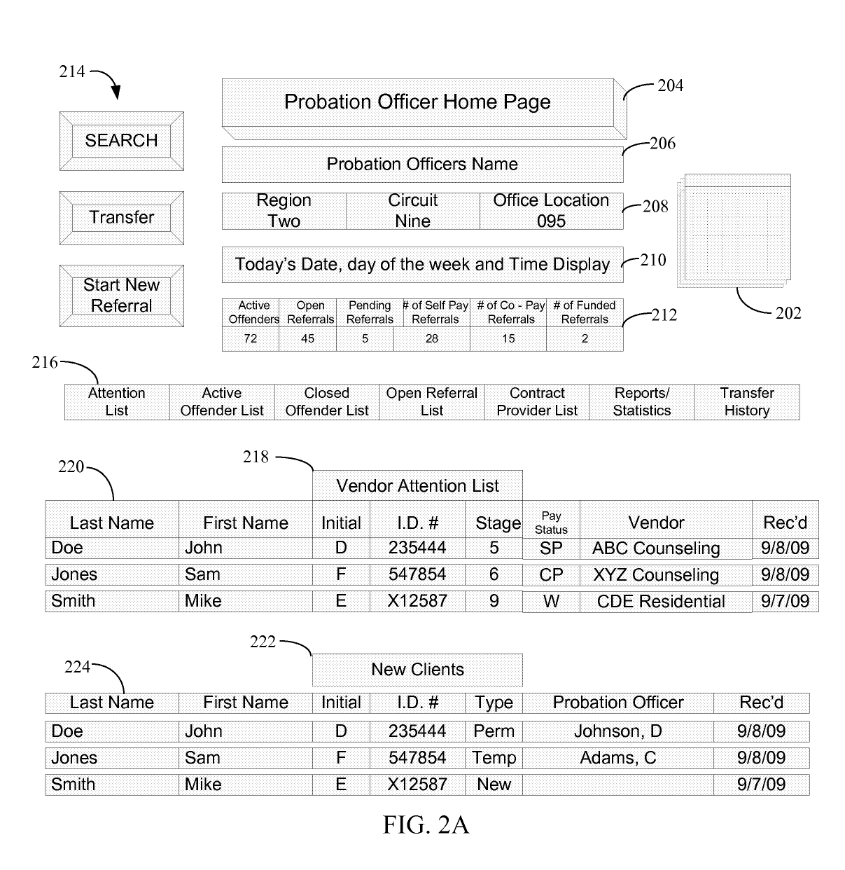

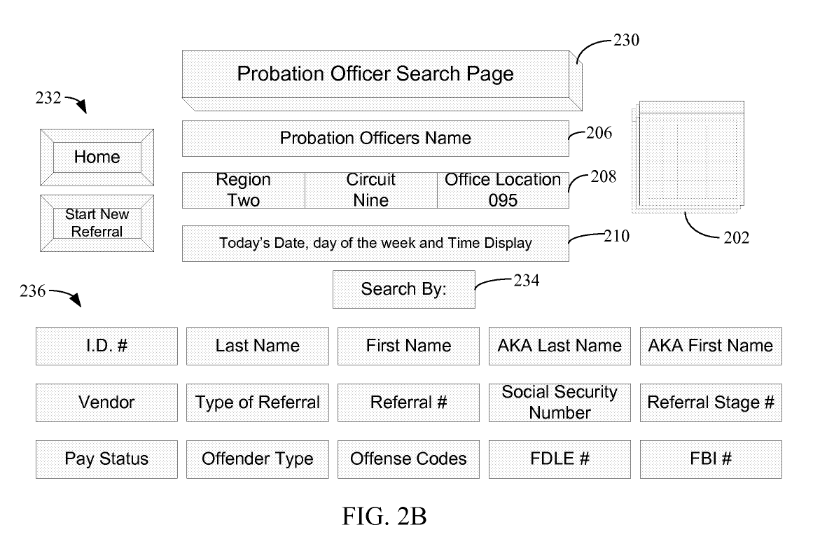

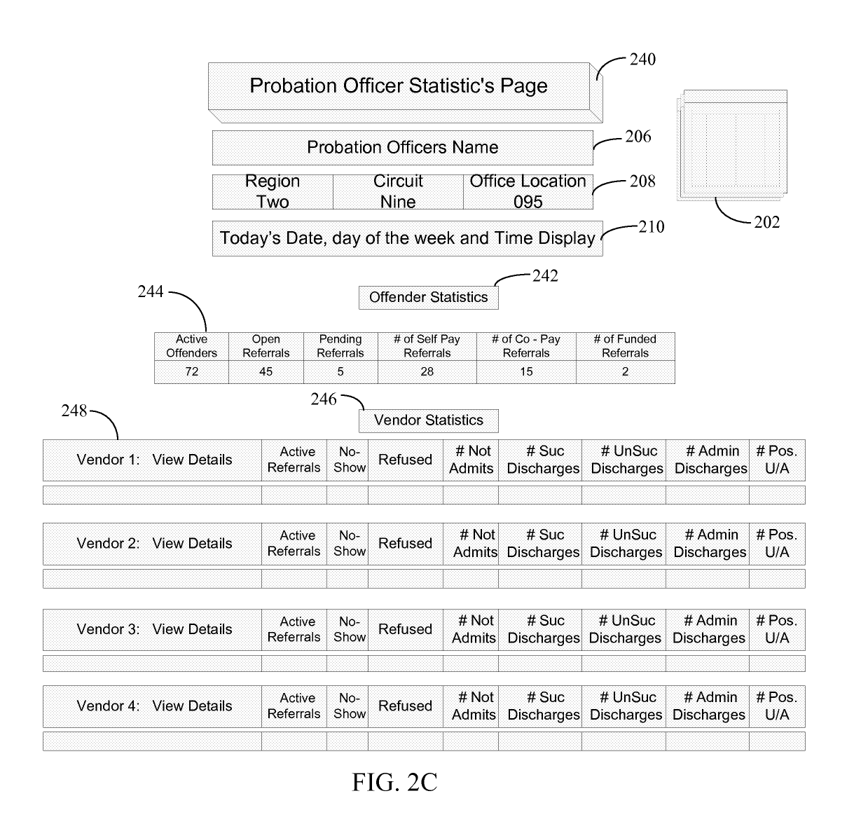

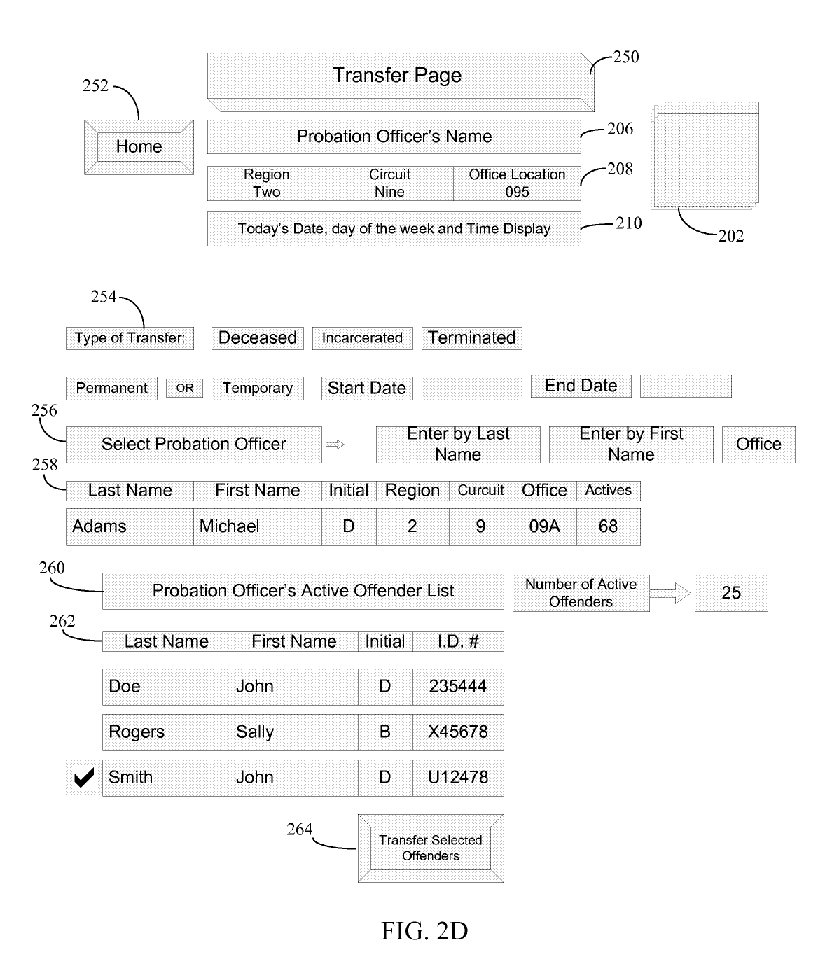

The Probation Officer (“PO”) may use a graphical user interface (“GUI”) to display data related to the referrals as shown in FIG. 2A. For example, the PO Home Page 204 displays the PO's name 206, the location 208, the current date/time 210, and a summary of the PO's referrals 212. The summary 212 may include a number of active offenders/client, open referrals, pending referrals, number of self pay referrals, number of co-pay referrals, number of funded referrals or any combination thereof. A calendar 202 may also be displayed. A menu 214 is displayed that allows the PO to select an activity to complete. For example, the PO may select from the menu 214 to search, transfer, or start a new referral. In addition, an option bar 216 provides a number of different groups of data for the PO to display and view. For example, the groups of data may include data related to clients on the attention list, active offender list, closed offender list, open referral list, contract provider/vendor list, reports/statistics, transfer history, or any combination thereof. The vendor attention list 218 is displayed in FIG. 2A, which provides data related to those clients 220 that currently require vendor attention. A list of new clients 22 may also be displayed, where the data 224 relates to the new clients.

If the PO selects to search from the menu 214, the PO Search Page 230 is displayed as shown in FIG. 2B. A menu 232 is displayed that allows the PO to select an activity to complete. The PO may also select from a number of different search terms 236 to find the information sought. For example, the search term may be by identification number, last name, first name, an alias, type of referral, vendor, pay status, offender type, offense codes, referral stage, referral number, FDLE#, FBI#, etc., or any combination thereof.

The PO may also generate statistics based on the referral data and display the statistics on the PO Statistics Page 240 as shown on FIG. 2C. For example, offender statistics 242 may be displayed that include offender data 244 such as active offenders, open referrals, pending referrals, number of self pay referrals, number of co-pay referrals, number of funded referrals, and any combination thereof. The vendor statistics 246 may include data 248 such as active referrals, no-shows, refused, number of not admitted, number of successful discharges, number of unsuccessful discharges, number of administrative discharges, etc., and any combination thereof.

Referring now to FIG. 2D, the Transfer Page 250 may be used to transfer the referral. A menu 252 is displayed that allows the user to select an activity to complete or return to the Home Page. The type of transfer 254 and the probation officer 256 may be selected using the GUI. The probation officer information 258 may be displayed along with the PO's active offender list 260. The active offender list may include data 262 of the names of the offenders and identification numbers. The offender may be selected and the transfer completed 264 using the GUI.

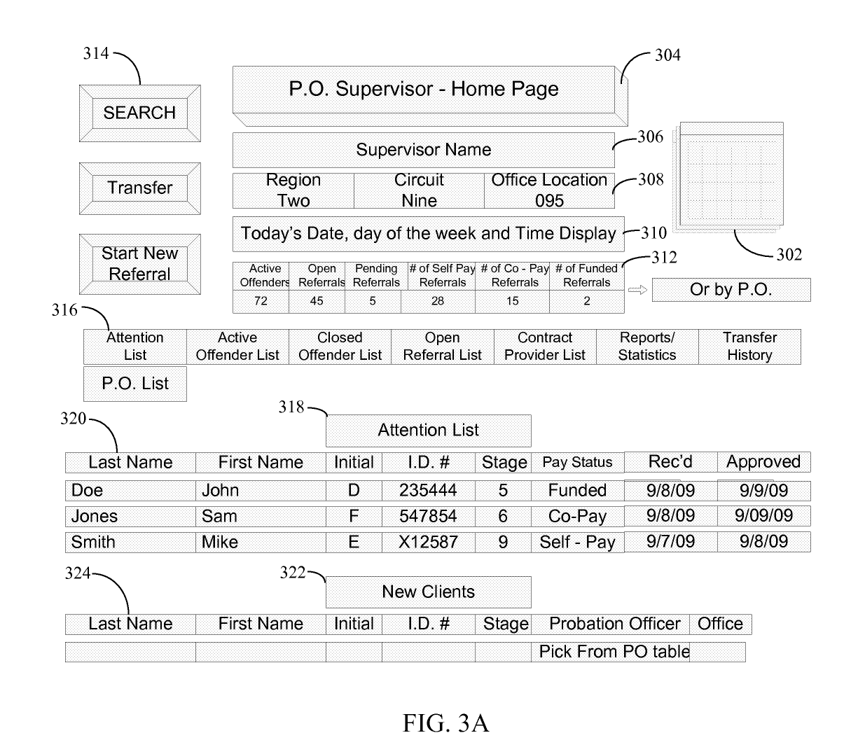

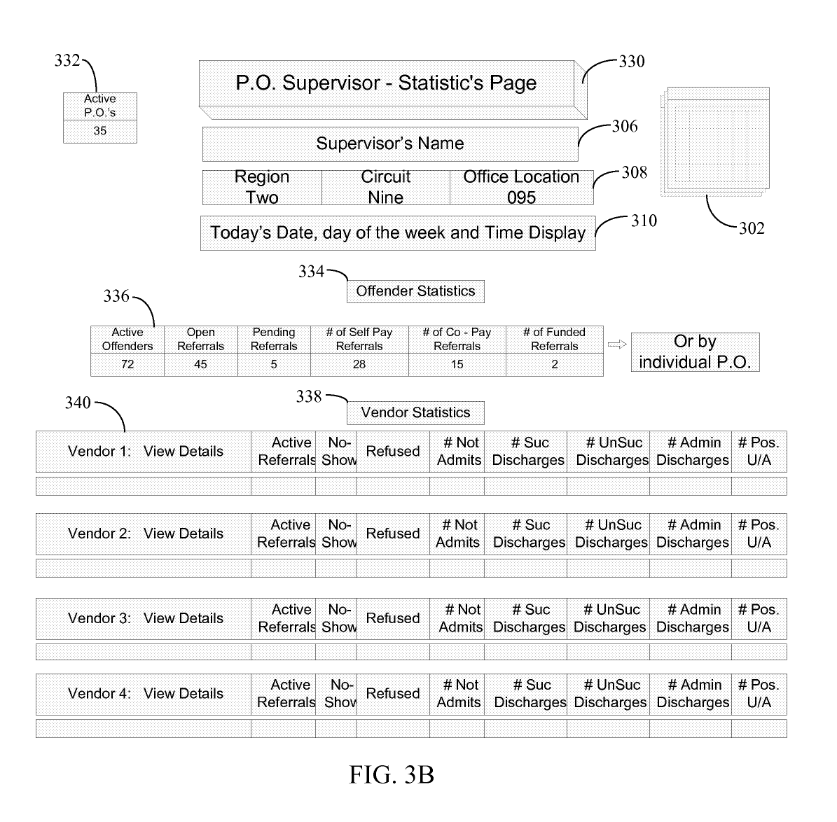

The PO Supervisor may use a GUI to display data related to the referrals as shown in FIG. 3A. For example, the PO Supervisor Home Page 304 displays the PO Supervisor's name 306, the location 308, the current date/time 310, and a summary of the referrals 312. The summary 312 may include a number of active offenders/client, open referrals, pending referrals, number of self pay referrals, number of co-pay referrals, number of funded referrals or any combination thereof. A calendar 302 may also be displayed. A menu 314 is displayed that allows the PO Supervisor to select an activity to complete. For example, the PO Supervisor may select from the menu 314 to search, transfer, or start a new referral. In addition, an option bar 316 provides a number of different groups of data for the PO Supervisor to display and view. For example, the groups of data may include data related to clients on the attention list, active offender list, closed offender list, open referral list, contract provider/vendor list, reports/statistics, transfer history, PO list, or any combination thereof. The attention list 318 is displayed in FIG. 3A, which provides data related to those clients 320 that currently require attention. A list of new clients 322 may also be displayed, where the data 324 relates to the new clients.

The PO Supervisor may also generate statistics based on the referral data and display the statistics on the PO Supervisor Statistics Page 330 as shown on FIG. 3B. The number of active POs 332 may be displayed. In addition, offender statistics 334 may be displayed that include offender data 336 such as active offenders, open referrals, pending referrals, number of self pay referrals, number of co-pay referrals, number of funded referrals, and any combination thereof. The vendor statistics 338 may include data 340 such as active referrals, no-shows, refused, number of not admitted, number of successful discharges, number of unsuccessful discharges, number of administrative discharges, etc., and any combination thereof.

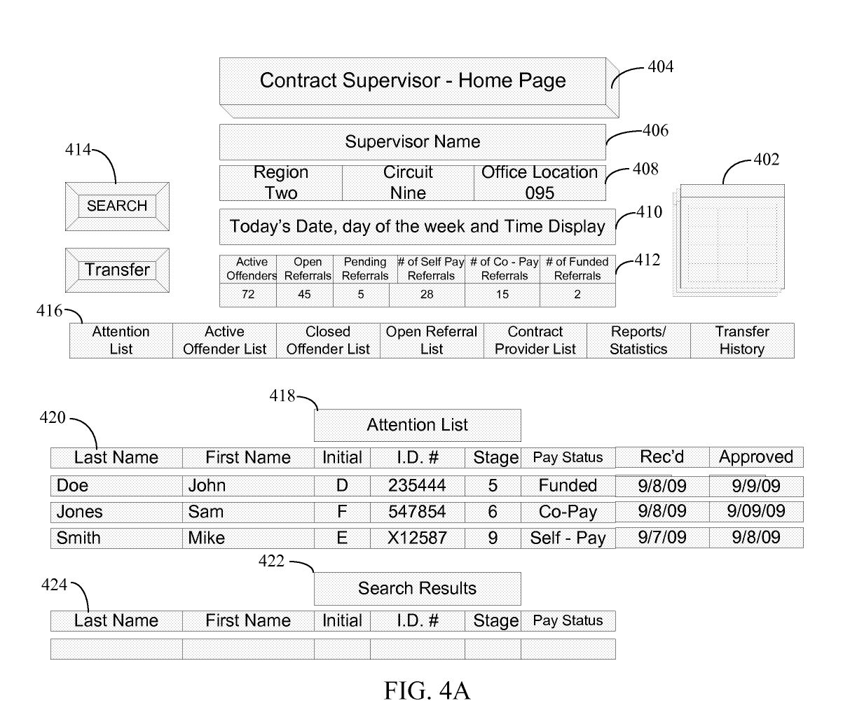

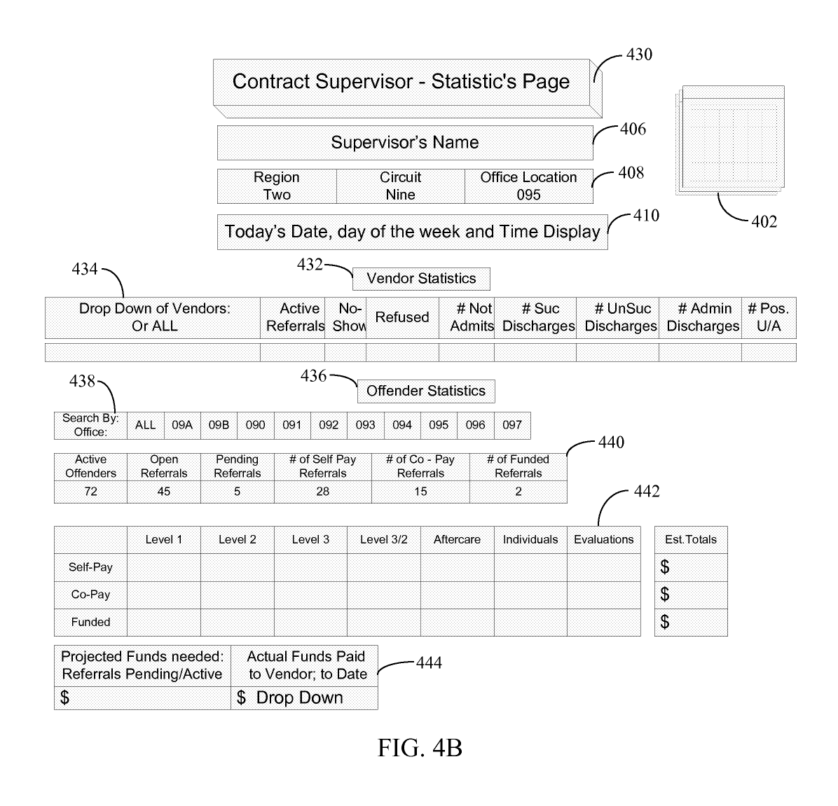

The Contract Supervisor may use a GUI to display data related to the referrals as shown in FIG. 4A. For example, the Contract Supervisor Home Page 404 displays the Supervisor's name 406, the location 408, the current date/time 410, and a summary of the referrals 412. The summary 412 may include a number of active offenders/client, open referrals, pending referrals, number of self pay referrals, number of co-pay referrals, number of funded referrals or any combination thereof. A calendar 402 may also be displayed. A menu 414 is displayed that allows the Supervisor to select an activity to complete. For example, the Supervisor may select from the menu 414 to search or transfer. In addition, an option bar 416 provides a number of different groups of data for the Supervisor to display and view. For example, the groups of data may include data related to clients on the attention list, active offender list, closed offender list, open referral list, contract provider/vendor list, reports/statistics, transfer history, or any combination thereof. The attention list 418 is displayed in FIG. 4A, which provides data related to those clients 420 that currently require attention. A list of search results 422 may also be displayed, where the data 424 may relate to the clients.

The Contract Supervisor may also generate statistics based on the referral data and display the statistics on the Supervisor Statistics Page 430 as shown on FIG. 4B. For example, offender statistics 436 may be searched 438 and displayed that include offender data 440 such as active offenders, open referrals, pending referrals, number of self pay referrals, number of co-pay referrals, number of funded referrals, and any combination thereof. The vendor statistics 432 may include data 434 such as active referrals, no-shows, refused, number of not admitted, number of successful discharges, number of unsuccessful discharges, number of administrative discharges, etc., and any combination thereof. A table 442 summarizing the amount of money for clients at each level and estimated monetary total may be provided. The projected funds needed for pending referrals and the actual funds paid to vendor to date may also be displayed in a table 444.

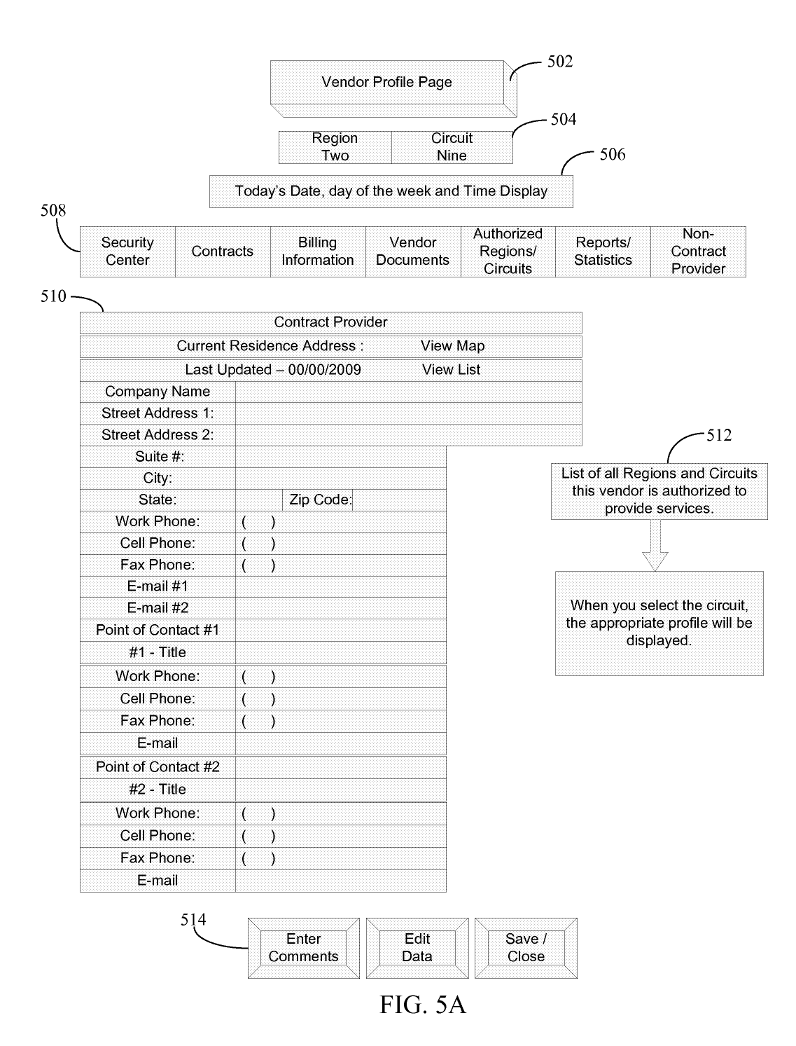

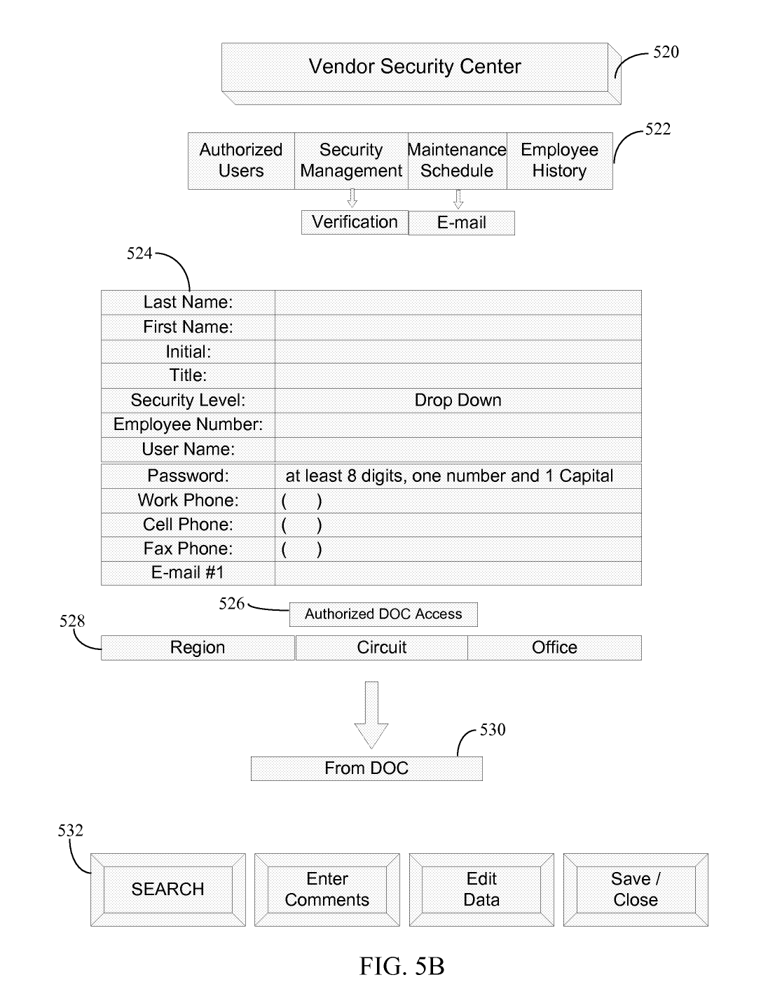

A Vendor Profile Page 502 is shown in FIG. 5A. The location of the vendor 504 is displayed along with the current date/time 506. A menu 508 is displayed that allows the user to view information related to a particular vendor. For example, the user may select security center, contracts, billing information, vendor documents, authorized regions/circuits, reports/statistics, non-contract provider, or any combination thereof. The contract provider (i.e. vendor) contact information 510 is displayed and may be edited. An option bar 514 allows a user to select to enter comments, edit data, and save/close the Vendor Profile Page. A list 512 of all regions and circuits the vendor is authorized to provide services may be displayed and when the user selects the circuit, the appropriate profile is displayed.

Referring now to FIG. 5B, the Vendor Security Center 520 allows a particular security level to be assigned to each user of the method and system for referral management. A menu 522 is displayed that allows an administrator user to view information related to a particular user 524 that may be accessing the system. An authorization menu 526 may be used according to each region, circuit and office 528 based on information from the DOC 530. An option bar 532 allows the user to select to search, enter comments, edit data, and save/close the Vendor Security Center.

The Offender Data Home Page 602 displays the offender's/client's photo 606. The location 608, the current date/time 610, and when the offender's data was last updated 612 may be displayed. A menu 614 is displayed that allows the user to select an activity to complete. For example, the user may select from the menu 614 to view the PO history, referral history, urinalysis screening history, contract provider information, reports/statistics, arrest history, residence history, or any combination thereof. In addition, the offender type 616 is indicated on the Offender Data Home Page 602. A summary of the offender data 618 may include eye color, hair color, religion, shoe size, gender, ethnicity, height, weight, identifying marks, citizenship, birth state and city, etc. The current residence 620 for the offender may be displayed along with the current work address 622 for the offender. An option bar 624 allows the user to select to start referral, enter comments, edit data, and save/close the Offender Data Home Page 602.

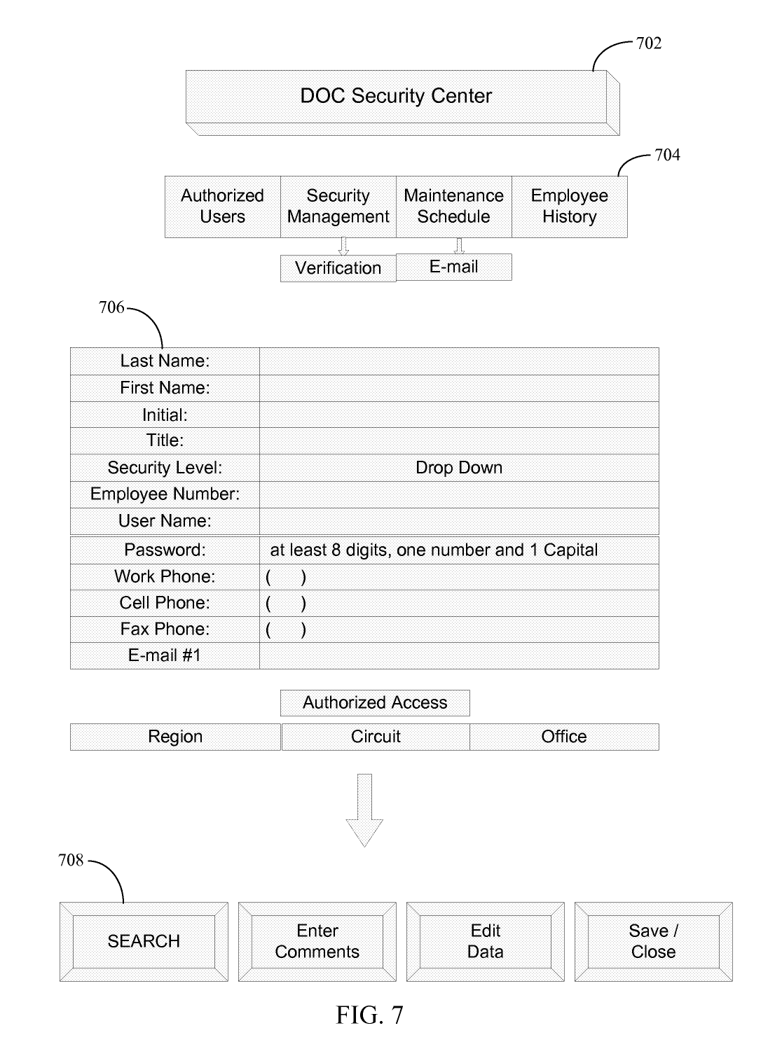

Referring now to FIG. 7, the DOC Security Center 702 allows a particular security level to be assigned to each user of the method and system for referral management. A menu 704 is displayed that allows an administrator user to view information related to a particular user 706 that may be accessing the system. An authorization menu may be used according to each region, circuit and office. An option bar 708 allows the user to select to search, enter comments, edit data, and save/close the DOC Security Center.

An Offender Notes History 802 allows a user to enter notes regarding a particular offender. For example, the type of note to enter is selected 804 to access the proper file. All notes entered are time stamped, the name of the person who entered the note recorded, and are capable of being sorted by type of note, time frames and individuals. The types of notes entered may include, PO notes 806, DOC staff notes 810, clerical notes 812, field noted 814, task notes 816, appointment dates/times 818. In addition, all notes 820 may be selected to be viewed.

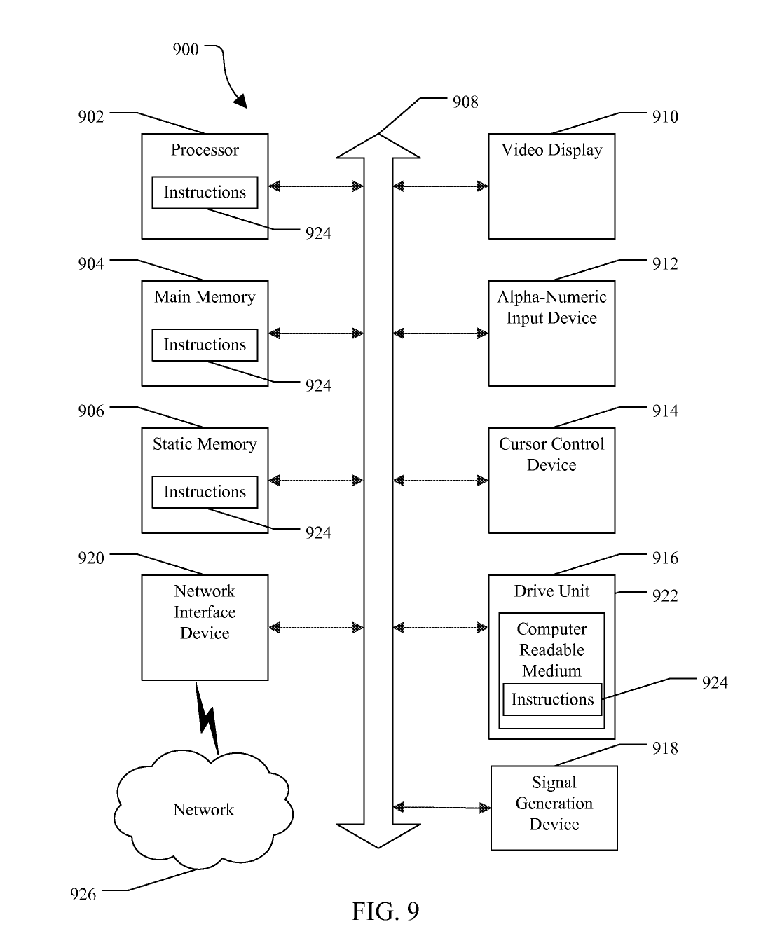

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices.

In a networked deployment, the computer system may operate in the capacity of a server, such as a video server or application server, or a media device. The computer system 900 can also be implemented as or incorporated into various devices, such as a personal computer (PC), a personal digital assistant (PDA), a mobile device, a palmtop computer, a laptop computer, a desktop computer, a communications device, a wireless telephone, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), a flat panel display, a solid-state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

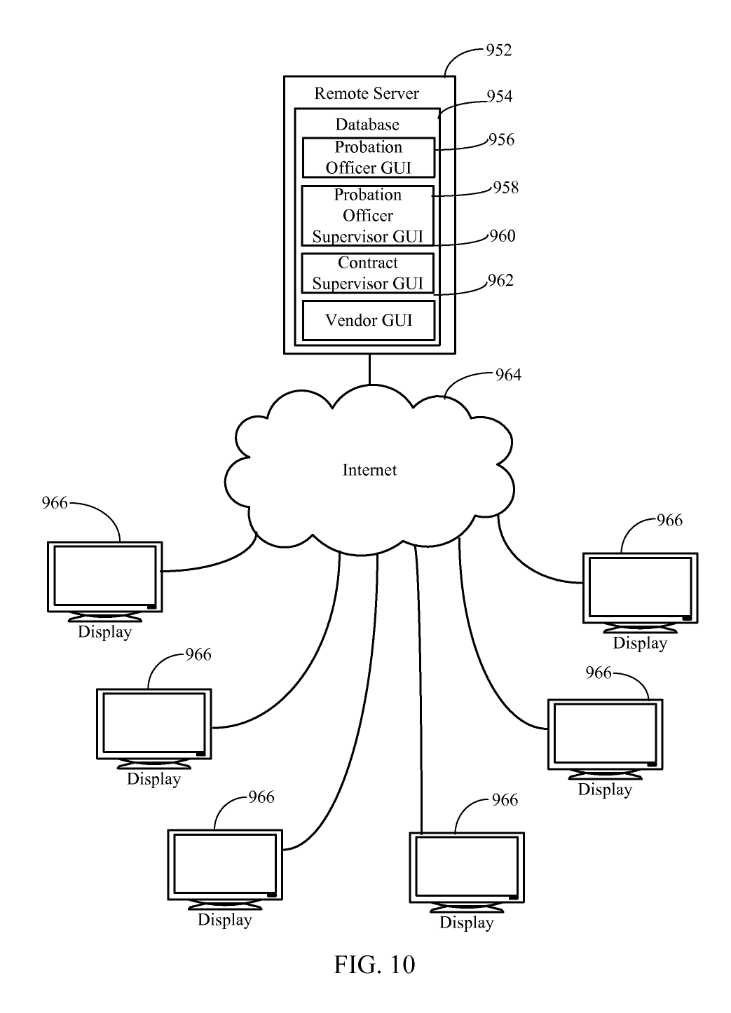

Referring to FIG. 10, a particular illustrative embodiment of a system for providing referral management is depicted. The system includes a remote server 952 that is used to store information regarding at least one referral and to determine in part whether a user is authorized to access the database 954. A user may access the remote server 952 via workstations 966 connected to the Internet 964. Once connected to the remote server 952, one of a plurality of graphical user interfaces (“GUI”) may be used to access, edit, and modify information stored in the database related to the referrals. The GUIs may include a Probation Officer GUI, Probation Officer Supervisor GUI, Contract Supervisor GUI, or a Vendor GUI. The database 954 may include information regarding referrals, probation officers, probation officer supervisors, vendors, and offenders. The remote server 952 may also includes a search module that may perform various functions, including receiving a search request for a referral, particular type of travel provider, determining which offenders/clients match the request, and displaying the results using a GUI. The search module may be implemented in hardware, firmware, software, other programmable logic, or any combination thereof.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined by the following claims.

What is claimed is:

1. A method of referral management, the method comprising:
receiving at least one referral request for a client submitted by a probation officer;
storing the at least one referral request to a database on a remote server;
transferring the at least one referral request to a probation officer supervisor;
forwarding the at least one referral request to a contract supervisor when the at least referral request is approved by the probation officer supervisor;
forwarding the at least one referral request to a vendor when the at least one referral request is approved by the contract supervisor;
receiving an acknowledgment that the at least one referral request was received by the vendor;
receiving an evaluation from the vendor of the client;
monitoring a progress of the client in a treatment program;
completion of the treatment program by the client;
notifying the contract supervisor of the completion of the treatment program by the client; and
closing the at least one referral request.

2. The method of claim 1, wherein the at least one referral request is submitted using a probation officer graphical user interface (“GUI”).

3. The method of claim 2, further comprising associating an electronic time stamp with the at least one referral request for each instance that the at least one referral request is forwarded and received.

4. The method of claim 3, further comprising accessing the database on the remote server using an Internet connection.

5. The method of claim 4, further comprising generating statistics of a time between the vendor receiving the acknowledgment of the at least one referral request and the evaluation of the client.

6. The method of claim 5, further comprising generating a record of the at least one referral request that includes a status of the client.

7. The method of claim 6, further comprising displaying a summary of data stored on the remote server for at least one client assigned to the probation officer, wherein the summary of data includes a number of open referrals, pending referrals, number of self pay referrals, number of co-pay referrals, number of funded referrals, or any combination thereof.

8. The method of claim 7, further comprising accessing a referral history of the client using a GUI.

9. The method of claim 8, further comprising:
searching the database for information of the client using at least one search term, wherein the search term includes last name, first name, type of referral request, social security number, pay status, or any combination thereof; and
displaying the information of the client based on a result of searching the database.

10. The method of claim 9, further comprising maintaining the database to contemporaneously update the referral request of each particular client.

11. A processor readable medium having processor instructions that are executable to cause a processor to:
receive at least one referral request for a client submitted by a probation officer;
store the at least one referral request to a database on a remote server;
transfer the at least one referral request to a probation officer supervisor;
forward the at least one referral request to a contract supervisor when the at least referral request is approved by the probation officer supervisor;
forward the at least one referral request to a vendor when the at least one referral request is approved by the contract supervisor;
receive an acknowledgment that the at least one referral request was received by the vendor;
receive an evaluation from the vendor of the client;
monitor a progress of the client in a treatment program;
notify the contract supervisor of the completion of the treatment program by the client; and
close the at least one referral request.

12. The processor readable medium of claim 11, wherein the processor executable instructions are further executable to display the referral request stored on the database.

13. The processor readable medium of claim 12, wherein the processor executable instructions are further executable to maintain the database to contemporaneously update the referral request for each client.

14. The processor readable medium of claim 13, wherein the at least one referral request is submitted using a probation officer graphical user interface (“GUI”).

15. The processor readable medium of claim 14, wherein the processor executable instructions are further executable to associate an electronic time stamp with the at least one referral request for each instance that the at least one referral request is forwarded and received.

16. The processor readable medium of claim 15, wherein the processor executable instructions are further executable to access the database on the remote server using an Internet connection.

17. The processor readable medium of claim 16, wherein the processor executable instructions are further executable to generate statistics of a time between the vendor receiving the acknowledgment of the at least one referral request and the evaluation of the client.

18. The processor readable medium of claim 17, wherein the processor executable instructions are further executable to generate a record of the at least one referral request that includes a status of the client.

19. The processor readable medium of claim 18, wherein the processor executable instructions are further executable to display a summary of data stored on the remote server for at least one client assigned to the probation officer, wherein the summary of data includes a number of open referrals, pending referrals, number of self pay referrals, number of co-pay referrals, number of funded referrals, or any combination thereof.

20. The processor readable medium of claim 19, wherein the processor executable instructions are further executable to access a referral history of the client stored on the database using a GUI.
